(19) United States
(12) Patent Application Publication
(10) Pub. No.: US 2026/0112637 A1
(43) Pub. Date: Apr. 23, 2026

(54) Use of novel fibrillizable binders in the dry electrode process to produce energy storage devices without organic solvents

(71) Applicant: Ziying Wang, San Diego, CA (US)

(72) Inventor: Ziying Wang, San Diego, CA (US)

(21) Appl. No.: 18/923,920

(22) Filed: Oct. 23, 2024

(51) Int. Cl. H01M 4/62; C08F 214/26; C08L 1/28; C08L 27/18; H01M 4/04; H01M 4/1397

(52) U.S. Cl. CPC H01M 4/623; C08F 214/26; C08F 214/262; C08L 1/286; C08L 27/18; H01M 4/0435; H01M 4/1397

(57) ABSTRACT

Disclosed is a novel fibrillizable binder for electrode production aimed at achieving better electrochemical performance than existing binders. The proposed binders are P3FE and copolymers of P3FE with PTFE, containing between 3-3.95 fluorine atoms per monomer unit.

### CROSS-REFERENCE TO RELATED APPLICATIONS

See application data sheet (ADS) associated with this specification.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of dry electrode manufacturing processes for producing electrodes used by energy storage devices, like lithium-ion batteries. Specifically, this subject matter relates to use of polytrifluoroethylene (P3FE) or copolymers of P3FE and polytetrafluoroethylene (PTFE) (P3FE-PTFE) as binder materials to enable solvent-free production of electrodes for lithium-ion batteries and other energy storage devices.

### BACKGROUND OF THE INVENTION

Lithium-ion batteries and other energy storage devices typically consist of three main components: a cathode (positive electrode), an anode (negative electrode), and an electrolyte between them. These devices operate on the principle of ion and electron movement. During charging, lithium ions migrate from the cathode to the anode through the electrolyte, while electrons flow through an external circuit. This process reverses during discharge.

Paired electrodes are crucial components in energy storage devices such as lithium-ion batteries. A typical pair of electrodes, shown in FIG. 0, consists of multiple layers, including a current collector 1110 of the first electrode 1100, an active material layer 1120 of the first electrode 1100, a current collector 1210 of the second electrode 1200, an active material layer 1220 of the second electrode 1200, and sometimes a separator 1300. The active material layers 1120,1220 are the focus of this disclosure. Active layers generally contain active materials, conductive additives, and binders. The binders play a critical role in maintaining the structural integrity of the electrode and ensuring good contact between the active materials and the current collector. The method of electrode fabrication can significantly impact its performance and the overall efficiency of the energy storage device. Traditional wet processes involve the use of solvents and require energy-intensive drying steps, while dry processes aim to eliminate these drawbacks. The following disclosure presents a novel approach to dry electrode manufacturing using innovative binder materials

To address these issues, researchers have developed “dry” electrode manufacturing processes that eliminate the need for solvents. One approach uses PTFE as a binder, as it can form a network of thin, nano-scale fibers (fibrils) to hold the electrode materials together. Polyvinylidene fluoride (PVDF) has also been used in dry electrode processes. These methods offer potential advantages such as simplified manufacturing, reduced environmental impact, and improved electrode properties.

The key property enabling dry battery electrode processing is the polymer's ability to fibrillate. PTFE can fibrillate due to the unique structure of its polymer chains and the electronegativity of fluorine atoms. PTFE has an all-trans conformation where the large Van der Waals radius of fluorine leads to a slight twist of the polymer chain. These chains are organized in a hexagonal or pseudo-hexagonal crystalline structure and a shearing force concentrated at a point can nucleate fibrillization. PVDF has many different phases and none of them fibrillate. The most common alpha phase has a trans-gauche-trans-gauche conformation, and this particular shape and the alternating hydrogen and fluorine atoms lead to significant interactions between polymer chains that prevent fibrillation. PVDF is generally dissolved in an organic solvent n-methyl-2-pyrrolidone (NMP) to be used in the wet coating process or mixed with active material and spray dried in the dry coating process.

However, neither PTFE nor PVDF is optimal for binding electrode materials. PTFE's high fluorine content can lead to capacity loss in anodes due to its reactivity at anodic potentials. During charging, PTFE can react with lithium ions to form LiF and carbon, resulting in significant capacity loss. PVDF has limitations in terms of anode electrode lifespan and usage of PVDF in cathode coating requires toxic organic solvents and large energy-intensive drying ovens.

Other polymers have been explored as potential binders. Such polymers include cellulose derivatives, polyolefins, polyethers, polysiloxanes, and their copolymers. While these can form free-standing films, they too have limitations. Consequently, there is a need for improved binding materials that offer reduced capacity loss in anodes compared to PTFE and longer electrode lifespans than PVDF-based electrodes.

### Listing of Related Art

R.R. Kolda and J.B. Lando, “The Effect of Hydrogen-Fluorine Defects on the Conformational Energy of Polytrifluoroethylene Chains” (1975)
Toshiharu Yagi, “Transitions and Relaxations in Poly(trifluoroethylene)” (1979)
Lovinger and Cais, “Structure and Morphology of Poly(trifluoroethylene)” (1984)
Tashiro et al., “Structural Study on Ferroelectric Phase Transition of Vinylidene Fluoride-Trifluoroethylene Copolymers (III) Dependence of Transitional Behavior on VDF Molar Content” (1984)
US 2024/0105955 A1 (2024)
US 2020/0313193 A1 (2020)
US 2019/0305316 A1 (2019)
U.S. Pat. No. 11,949,089 B2 (2024)
U.S. Pat. No. 11,637,289 B2 (2023)
U.S. Pat. No. 11,367,864 B2 (2022)

### SUMMARY OF THE INVENTION

This specification discloses a novel fibrillizable binder for electrode production aimed at achieving better electrochemical performance than existing binders. The proposed binders are P3FE and copolymers of P3FE with PTFE, containing between 3-3.95 fluorine atoms per monomer unit. Specifically, the disclosure focuses on P3FE or P3FE-PTFE copolymers with a defect rate of approximately 22% or more and a carbon to fluorine ratio between 2:3 and 2:3.95, with a preferred embodiment having a carbon to fluorine ratio of 2:3.5. These binders are expected to be fibrillizable like PTFE, forming thin fibrils that bind electrode materials without solvents. A key innovation is that P3FE and P3FE/PTFE copolymers maintain PTFE's beneficial fibrillization properties while potentially improving electrochemical performance. The presence of hydrogen atoms in P3FE is thought to disrupt electrochemical reduction reactions that occur with pure PTFE, potentially reducing capacity loss in battery anodes.

These binders are used to create free-standing electrode films through dry mixing and calendering processes, which can then be laminated onto current collectors to form battery electrodes. This approach aims to enable solvent-free electrode manufacturing while overcoming limitations of PTFE binders in battery applications. The disclosed binder is expected to combine the beneficial properties of both PVDF and PTFE, potentially reducing irreversible capacity loss in anodes while maintaining the ability to form self-supporting electrode films through dry processing methods..

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 0 is an illustration of a pair of electrodes;

FIG. 1 is a table of TTTT and TGTG′ conformations of PVDF, P3FE, P3FE-PTFE, and PTFE;

FIG. 2 is plot of Molecular cross-sectional area verses F-Atoms per —C—C— repeat; and,

FIG. 3 is a flow chart of a typical electrode process according to the present specification.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFFERED EMBODIMENTS

This disclosure introduces compositions and methods for creating dry electrode films for energy storage devices like lithium-ion batteries using novel binder materials, specifically P3FE and copolymers of P3FE and PTFE. These binders are used to create free-standing electrode films through dry processing methods.

P3FE contains 3 fluorine atoms per monomer unit, while copolymers of P3FE and PTFE result in fluorine content between 3 and 3.95 per monomer. The specification also discloses the use of P3FE or a copolymer of P3FE and PTFE with a defect rate of approximately 22% or more and a carbon to fluorine ratio between 2:3 and 2:3.95 as a binder in dry battery electrode manufacturing. A preferred embodiment of the disclosed binder has a carbon to fluorine ratio of 2:3.5.

PTFE is a synthetic fluoropolymer with the chemical formula —(C2F4)n-, commonly known as Teflon, with CAS number 9002-84-0. It's formed by polymerizing tetrafluoroethylene (TFE, CF2═CF2, CAS 116-14-3), resulting in a high molecular weight polymer (400,000-10,000,000 amu) composed only of carbon and fluorine atoms. PTFE's unique properties stem from its strong carbon-fluorine bonds, making it highly inert, chemically resistant, hydrophobic, and having a low coefficient of friction.

P3FE is a fluoropolymer containing 3 fluorine atoms and 1 hydrogen atom per 2 backbone carbon atoms, with the chemical formula —(CF2—CFH)n-. Its asymmetrical structure results in an atactic polymer without a repeating stereochemical configuration. P3FE chains have a defect rate of 10-50% depending on synthesis conditions. P3FE chains adopt a 3/1 helical conformation at defect rates below 21-22% and an all-trans conformation at higher defect rates. Despite its irregularity, P3FE is crystalline.

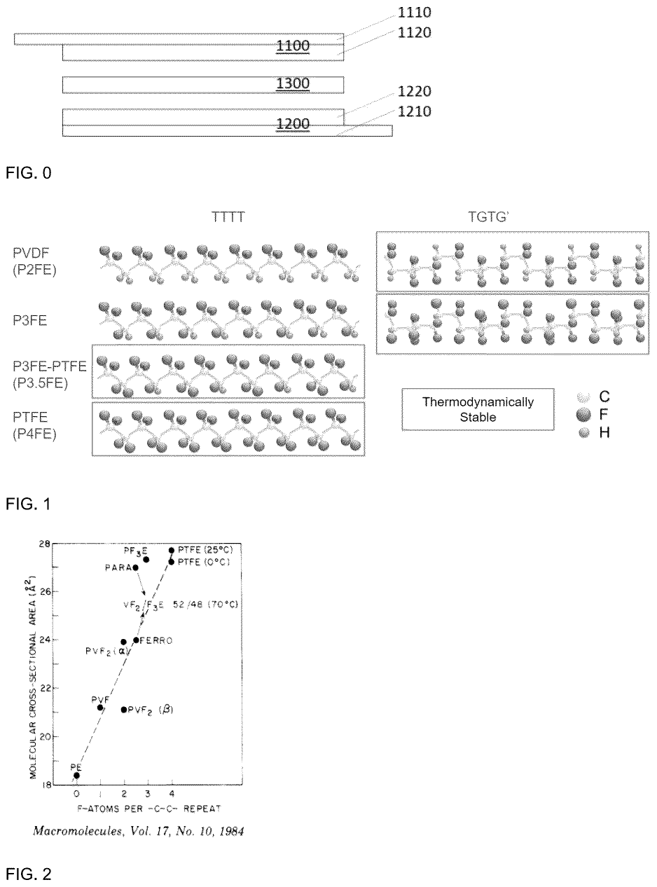

FIG. 1 presents a table comparing the TTTT and TGTG′ conformations of PVDF, P3FE, P3FE-PTFE copolymer, and PTFE. FIG. 2 illustrates the relationship between molecular cross-sectional area and the number of fluorine atoms per —C—C— repeat unit. These figures provide evidence for the fibrillizability of P3FE, even in its TGTG′ configuration, based on the molecular cross-sectional area of the polymer chain. While alpha phase PVDF in the TGTG′ configuration has a molecular cross-sectional area of 24 Å², which is approximately midway between PE and PTFE, P3FE in the TGTG′ configuration exhibits a cross-sectional area of about 27.5 Å² , similar to that of PTFE. This suggests that the bond angles between every second carbon atom (where the trans bond exceeds 120 degrees) slightly elongate the polymer chain. This elongation likely occurs because in every second carbon layer along the chain, the presence of three fluorine atoms causes them to repel each other. Consequently, this interaction may subtly straighten the 3/1 helix structure of the polymer.

A copolymer of P3FE and PTFE is a fluoropolymer composed of repeating units of trifluoroethylene (CF2═CFH) and tetrafluoroethylene (CF2═CF2). Its chemical formula can be expressed as —(CF2—CFH)x-(CF2—CF2)y-, where x and y denote the number of repeating units for each monomer in the copolymer chain. The specific values of x and y vary depending on the copolymer's composition. This copolymer doesn't have a unique CAS number due to its variable composition. It combines properties of P3FE (three fluorine atoms per monomer unit) and PTFE (four fluorine atoms per monomer unit), resulting in a fluorine content between 3 and 3.95 atoms per monomer unit. To achieve a carbon to fluorine ratio between 2:3 and 2:3.95, x can be any positive integer, while y should range from 0.0633x to 3x. For a 2:3.5 ratio, x can be any positive integer and y should equal 2x. Although this copolymer lacks widely recognized tradenames, it may be referred to in scientific literature as P(TrFE-TFE) or poly(trifluoroethylene-co-tetrafluoroethylene). By adjusting the P3FE to PTFE ratio, the copolymer's properties can be tailored, potentially offering a balance of characteristics from each homopolymer, such as crystallinity, melting point, and chemical resistance.

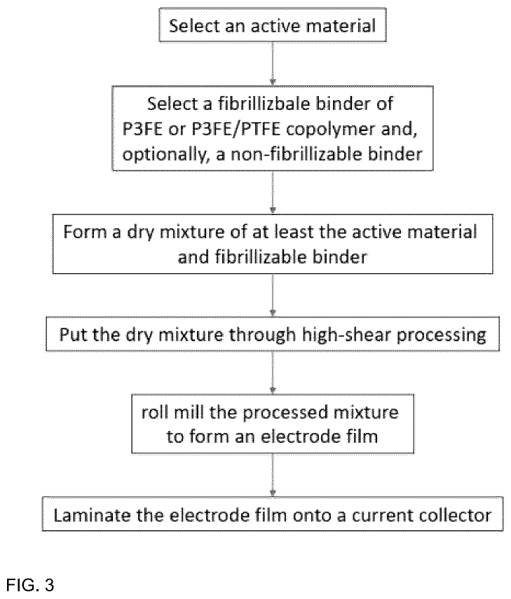

The fibrillization properties of P3FE and P3FE/PTFE copolymers, stemming from their crystallinity, trans configuration, and fluorine electronegativity, enable a solvent-free dry battery electrode manufacturing process. This process is applicable for both cathode and anode production. An exemplary process flow is depicted in FIG. 3. As shown, e.g., for cathodes, active materials (e.g., lithium metal oxides) are mixed with conductive carbon and the fibrillizable binder (P3FE or P3FE/PTFE copolymer), and optionally a non-fibrillizable binder. For anodes, active materials (e.g., graphite or silicon) are mixed with the fibrillizable binder and/or a non-fibrillizable binder. The next step may be that the dry mixture undergoes high shear processing, such as jet milling, to fibrillize the binder, creating a network of thin, web-like fibers. After that, this processed mixture is then calendered or roll milled to form a self-supporting electrode film, which can then be laminated onto current collectors to create the final battery electrodes.

A key advantage of P3FE or P3FE/PTFE copolymers over pure PTFE is their potentially improved electrochemical stability, particularly for anodes. The hydrogen atoms in P3FE are expected to disrupt the electrochemical reduction that occurs with PTFE, potentially reducing irreversible capacity loss. This dry electrode manufacturing process offers several benefits: it's more environmentally friendly than traditional solvent-based processes, potentially lowers production costs, and may result in electrodes with improved cohesion, adhesion to current collectors, and enhanced electrochemical performance. Overall, this novel binder-based dry process aims to improve battery electrode manufacturing in terms of both environmental impact and electrode quality.

In certain embodiments, the P3FE and P3FE-PTFE copolymers described herein may be further modified to enhance their properties. Specifically, 1-5% of common modifiers for fluorinated polymers can be incorporated into the polymer structure. These modifiers may include hexafluoropropylene (HFP), perfluoromethyl vinyl ether (PMVE), perfluoroethyl vinyl ether (PEVE), and perfluoropropyl vinyl ether (PPVE). The addition of these modifiers can potentially alter the physical and chemical properties of the polymers, such as improving their processability, thermal stability, or chemical resistance. This modification allows for further fine-tuning of the binder properties to meet specific requirements in electrode fabrication and performance.

Although the method and apparatus is described above in terms of various exemplary embodiments and implementations, it should be understood that the various features, aspects, and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more,” or the like; and adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A method for manufacturing a dry electrode for an energy storage device, comprising:
a) providing a fibrillizable binder material selected from the group consisting of polytrifluoroethylene (P3FE) and copolymers of P3FE and polytetrafluoroethylene (PTFE);
b) mixing the fibrillizable binder material with at least one active electrode material and optionally conductive additives to form a dry mixture, without the use of solvents;
c) processing the dry mixture under high shear forces to fibrillize the binder material and create a network of thin web-like fibers;
d) feeding the processed dry mixture into a calender or roll mill to form a self-supporting electrode film;
e) laminating the self-supporting electrode film onto a current collector to form a final battery electrode; and,
wherein the fibrillizable binder material provides improved electrochemical stability compared to pure PTFE, resulting in reduced irreversible capacity loss in the final battery electrode.

2. The method of claim 1 wherein wherein the at least one active electrode material comprises graphite.

3. The method of claim 1, wherein the fibrillizable binder material comprises a copolymer of P3FE and PTFE.

4. The method of claim 1, further comprising adding a non-fibrillizable binder to the dry mixture.

5. The method of claim 4, wherein the non-fibrillizable binder comprises carboxymethylcellulose (CMC).

6. The method of claim 5, wherein processing the dry mixture under high shear forces comprises jet milling.

7. The method of claim 6, wherein the self-supporting electrode film has a thickness of about 50 microns to about 300 microns.

8. A binder composition for use in an electrode of an energy storage device, the binder composition comprising:
a copolymer of polytrifluoroethylene (P3FE) and polytetrafluoroethylene (PTFE), wherein the copolymer has a repeating unit represented by the formula: —(CF2—CFH)x-(CF2—CF2)y- where x and y are positive integers; and
wherein the ratio of x to y is selected such that the carbon to fluorine ratio in the copolymer is between 2:3 and 2:3.95.

9. The binder composition of claim 8, wherein the ratio of x to y is selected such that the carbon to fluorine ratio in the copolymer is about 2:3.5.

10. The binder composition of claim 8, wherein the copolymer has a tail-to-tail or head-to-head defect rate of approximately 22% or more.

11. The binder composition of claim 8, further comprising a non-fibrillizable binder.

12. The binder composition of claim 11, wherein the non-fibrillizable binder comprises carboxymethylcellulose (CMC).

13. A binder composition for use in an electrode of an energy storage device, the binder composition comprising:
a copolymer of polytrifluoroethylene (P3FE) and polytetrafluoroethylene (PTFE), wherein the copolymer has a repeating unit represented by the formula —(CF2—CFH)x-(CF2—CF2)y-;
where x and y are positive integers;
wherein the copolymer further comprises 1-5% of one or more modifiers selected from the group consisting of hexafluoropropylene (HFP), perfluoromethyl vinyl ether (PMVE), perfluoroethyl vinyl ether (PEVE), and perfluoropropyl vinyl ether (PPVE).

14. The binder composition of claim 13, wherein the ratio of x to y is selected such that the carbon to fluorine ratio in the copolymer is between 2:3 and 2:3.95.

15. The binder composition of claim 13, wherein the copolymer has a tail-to-tail or head-to-head defect rate of approximately 22% or more.

16. The binder composition of claim 13, wherein the one or more modifiers comprise hexafluoropropylene (HFP).

17. The binder composition of claim 13, wherein the one or more modifiers comprise perfluoromethyl vinyl ether (PMVE).

18. The binder composition of claim 13, wherein the one or more modifiers comprise perfluoroethyl vinyl ether (PEVE).

19. The binder composition of claim 3, wherein the one or more modifiers comprise perfluoropropyl vinyl ether (PPVE).

20. The binder composition of claim 13, further comprising a non-fibrillizable binder.
